(19) United States
(12) Patent Application Publication
(10) Pub. No.: US 2015/0323801 A1
(43) Pub. Date: Nov. 12, 2015

(54) DISPLAY DEVICE AND DISPLAY SYSTEM

(71) Applicant: SHENZEN CHINA STAR OPTOELECTRONICS TECHNOLOGY CO., LTD., Shenzhen, Guangdong (CN)

(72) Inventor: Qiaosheng Liao, Shenzhen (CN)

(21) Appl. No.: 14/360,932

(22) PCT Filed: Mar. 24, 2014
(86) PCT No.: PCT/CN2014/073932

§ 371 Date: May 28, 2014

(30) Foreign Application Priority Data
Mar. 12, 2014 (CN) 201410089065.8

(51) Int. Cl. G02B 27/22; G02F 1/13363; G02F 1/1343; G02F 1/1335

(52) U.S. Cl. CPC G02B 27/22; G02F 1/133528; G02F 1/13363; G02F 1/13439; G02F 2001/133638

(57) ABSTRACT

A display device is disclosed herein, which comprises: a first display panel configured to emit a first light along a first direction and emit a second light along a second direction opposite to the first direction, and a second display panel configured to emit a third light along the first direction and reflect the second light along the first direction, wherein the first display panel is further provided with the third light transmitting therethrough, and the first display panel and the second display panel are overlaid integrally in sequence along the first direction.

### FIELD OF THE INVENTION

The present invention relates to the technical field of display techniques, and in particular to, a display device and a display system.

### BACKGROUND OF THE INVENTION

Commonly, traditional 3D (three-dimensional) displays have functioned on 3D graphics and 2D (two-dimensional) image display.

In practice, the present inventors have found that the prior art at least has the following problems:

3D images of conventional 3D displays are displayed at only half resolution, so the quality of conventional 3D image displays is low.

Therefore, it is necessary to provide a new technical solution to solve the conventional technical problem.

### SUMMARY OF THE INVENTION

In view of this, an objective of the present invention is to provide a display device and a display system with a capability of displaying a higher quality stereoscopic image.

In order to solve the aforementioned drawbacks of the prior art, the embodiment of the present invention provides a technical solution as follows:

a display device, comprising: a first display panel configured to emit a first light along a first direction and emit a second light along a second direction opposite to the first direction, the first light being a light beam where a first image displayed on the first display panel corresponds on the first direction, the second light being a light beam where the first image corresponds on the second direction, and a second display panel configured to emit a third light along the first direction and reflect the second light along the first direction, the third light being a light beam where a second image displayed on the second display panel corresponds on the first direction, wherein the first display panel is further provided with the third light transmitting therethrough, the first direction is perpendicular to a plane where the first display panel is located, the first direction is a direction where a gravity center or a center of the second display panel is directed towards a gravity center or a center of the first display panel, the first display panel and the second display panel are overlaid integrally in sequence along the first direction, and the display device further comprising: a polarizing plate disposed between the first display panel and the second display panel, and provided with converting the second light into a first linearly polarized light having a first polarization direction, and an optical rotation plate disposed between the polarizing plate and the second display panel, and provided with converting the second light reflected by the second display panel, into a second linearly polarized light having a second polarization direction perpendicular to the first polarization direction, and the polarizing plate further configured to block the second linearly polarized passing therethrough.

In the above-described device, the optical rotation plate is a quarter-wave plate. The quarter-wave plate is configured to convert the first linearly polarized light into a circularly polarized light having a first rotation state. The second display panel reflects the circularly polarized light in the first rotation state along the first direction to make the circularly polarized light having a second rotation state. The quarter-wave plate is further configured to convert the circularly polarized light having the second rotation state, into the second linearly polarized light.

In the above-described display device, the first rotation state is a right-handed state/left-handed state, and the second rotation state is a left-handed state/right-handed state.

In the above-described display device, the optical rotation plate is a liquid crystal cell configured to convert the first linearly polarized light into a third linearly polarized light having a third polarization direction. The second display panel is further configured to reflect the third linearly polarized light along the first direction. The liquid crystal cell is configured to convert the third linearly polarized light emitted by the second display panel, into the second linearly polarized light.

In the above-described display device, the liquid crystal cell comprises: a first substrate, a liquid crystal layer and a second substrate wherein the first substrate and the second substrate are overlaid integrally, the liquid crystal layer has liquid crystal molecules and disposed between the first substrate and the second substrate, each of which is disposed with a transparent electrode, and the first substrate and the second substrate apply an electric field on the liquid crystal molecules to commonly control a deflected state of the liquid crystal molecules so that a deflection direction of the first linearly polarized light is changed.

In the above-described display device, the optical rotation plate is further provided with the third light passing therethrough. The polarizing plate is configured to convert the third light passing through the optical rotation plate, into a fourth linearly polarized light having the first polarization direction.

The present invention further provides a display device, comprising: a first display panel configured to emit a first light along a first direction and emit a second light along a second direction opposite to the first direction, the first light being a light beam where a first image displayed on the first display panel corresponds on the first direction, the second light being a light beam where the first image corresponds on the second direction, and a second display panel configured to emit a third light along the first direction and reflect the second light along the first direction, the third light being a light beam where a second image displayed on the second display panel corresponds on the first direction, wherein the first display panel is further provided with the third light transmitting therethrough, the first direction is perpendicular to a plane where the first display panel is located, the first display panel and the second display panel are overlaid integrally in sequence along the first direction.

In the above-described display device, the display device further comprises: a polarizing plate disposed between the first display panel and the second display panel, and provided with converting the second light into a first linearly polarized light having a first polarization direction, and an optical rotation plate disposed between the polarizing plate and the second display panel and provided with converting the second light reflected by the second display panel, into a second linearly polarized light having a second polarization direction perpendicular to the first polarization direction. The polarizing plate is further configured to block the second linearly polarized passing therethrough.

In the above-described display device, the optical rotation plate is a quarter-wave plate. The quarter-wave plate is configured to convert the first linearly polarized light into a circularly polarized light having a first rotation state. The second display panel reflects the circularly polarized light in the first rotation state along the first direction to make the circularly polarized light having a second rotation state. The quarter-wave plate is further configured to convert the circularly polarized light having the second rotation state, into the second linearly polarized light.

In the above-described display device, the first rotation state is a right-handed state/left-handed state, and the second rotation state is a left-handed state/right-handed state.

In the above-described display device, the optical rotation plate is a liquid crystal cell. The liquid crystal cell is configured to convert the first linearly polarized light into a third linearly polarized light having a third polarization direction. The second display panel is further configured to reflect the third linearly polarized light along the first direction. The liquid crystal cell is configured to convert the third linearly polarized light emitted by the second display panel, into the second linearly polarized light.

In the above-described display device, the liquid crystal cell comprises: a first substrate, a liquid crystal layer and a second substrate, wherein the first substrate and the second substrate are overlaid integrally, the liquid crystal layer has liquid crystal molecules and disposed between the first substrate and the second substrate, each of which is disposed with a transparent electrode, the first substrate and the second substrate apply an electric field on the liquid crystal molecules to commonly control a deflected state of the liquid crystal molecules so that a deflection direction of the first linearly polarized light is changed.

In the above-described display device, the optical rotation plate is further provided with the third light passing therethrough. The polarizing plate is configured to convert the third light passing through the optical rotation plate, into a fourth linearly polarized light having the first polarization direction.

The present invention further provides a display system, comprising: polarized glasses and a first display panel configured to emit a first light along a first direction and emit a second light along a second direction opposite to the first direction, the first light being a light beam where a first image displayed on the first display panel corresponds on the first direction, the second light being a light beam where the first image corresponds on the second direction, and a second display panel configured to emit a third light along the first direction and reflect the second light along the first direction, the third light being a light beam where a second image displayed on the second display panel corresponds on the first direction, wherein the first display panel is further provided with the third light transmitting therethrough, the first display panel and the second display panel are overlaid integrally in sequence along the first direction.

In the above-described display system, the display device further comprises: a polarizing plate disposed between the first display panel and the second display panel, and provided with converting the second light into a first linearly polarized light having a first polarization direction, and an optical rotation plate disposed between the polarizing plate and the second display panel, and provided with converting the second light reflected by the second display panel, into a second linearly polarized light having a second polarization direction perpendicular to the first polarization direction. The polarizing plate further is configured to block the second linearly polarized passing therethrough.

In the above-described display system, the optical rotation plate is a quarter-wave plate. The quarter-wave plate is configured to convert the first linearly polarized light to a circularly polarized light having a first rotation state. The second display panel reflects the circularly polarized light in the first rotation state along the first direction to make the circularly polarized light having a second rotation state. The quarter-wave plate is further configured to convert the circularly polarized light having the second rotation state, into the second linearly polarized light.

In the above-described display system, the first rotation state is a right-handed state/left-handed state, and the second rotation state is a left-handed state/right-handed state.

In the above-described display system, the optical rotation plate is a liquid crystal cell. The liquid crystal cell is configured to convert the first linearly polarized light into a third linearly polarized light having a third polarization direction. The second display panel is further configured to reflect the third linearly polarized light along the first direction. The liquid crystal cell is configured to convert the third linearly polarized light emitted by the second display panel, into the second linearly polarized light.

In the above-described display system, the liquid crystal cell comprises: a first substrate, a liquid crystal layer and a second substrate, wherein the first substrate and the second substrate are overlaid integrally, the liquid crystal layer has liquid crystal molecules, the liquid crystal layer is disposed between the first substrate and the second substrate, each of the first substrate and the second substrate is disposed with a transparent electrode, the first substrate and the second substrate apply an electric field on the liquid crystal molecules to commonly control a deflected state of the liquid crystal molecules so that a deflection direction of the first linearly polarized light is changed.

In the above-described display system, the optical rotation plate is further provided with the third light passing therethrough. The polarizing plate is configured to convert the third light passing through the optical rotation plate, into a fourth linearly polarized light having the first polarization direction.

Compared with the prior art, a stereoscopic image displayed on the display device and the display system according to the present invention displays full resolution and therefore is capable of having a higher quality stereoscopic image display. In addition, the display device and the display system of the present invention can simultaneously display two-dimensional images and three-dimension images.

To make the above embodiments of the invention more comprehensible, the preferred embodiments being adopted by the present invention to achieve the above and other objectives can be best understood by referring to the following detailed description of the preferred embodiments and the accompanying drawings as detailed below.

### DESCRIPTION OF THE DRAWINGS

FIG. 1 is a schematic view of the display device according to a first preferred embodiment of the present invention;

FIG. 2 is a schematic view of display mode of the display device of FIG. 1;

FIG. 3 is a schematic view of the display device according to a second preferred embodiment of the present invention; and

FIG. 4 is a schematic view of the display system according to the first preferred embodiment of the present invention.

### DETAILED DESCRIPTION OF THE PREFERRED EMBODIMENTS

The preferred embodiments adopted by the present invention are given in the following detailed description, with reference to the drawings.

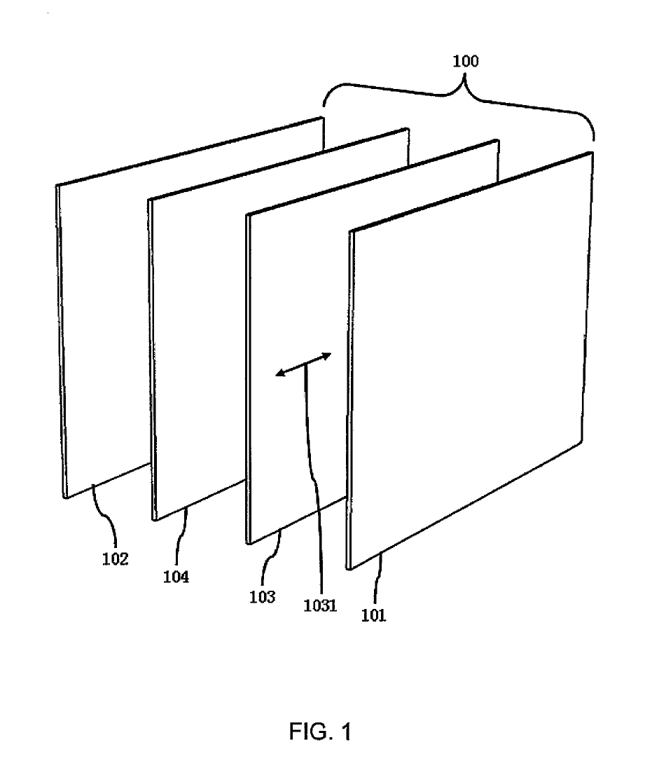

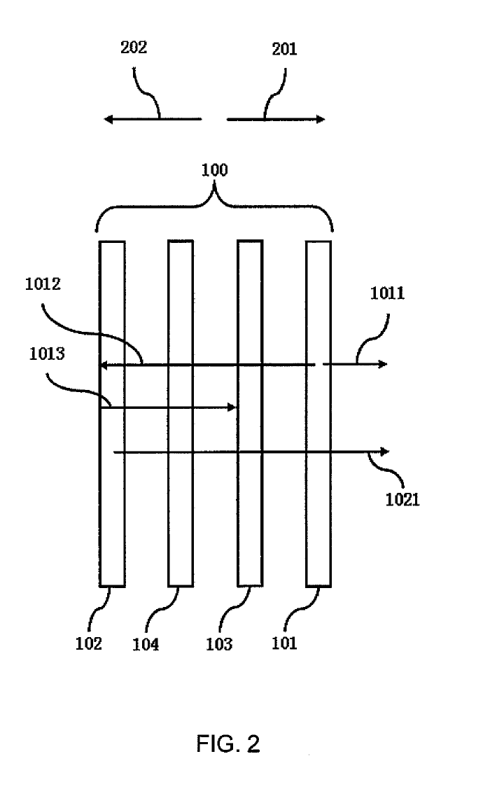

Now referring to FIG. 1 and FIG. 2, FIG. 1 is a schematic view of the display device 100 according to the first preferred embodiment of the present invention, and FIG. 2 is a schematic view of display mode of the display device 100 shown in FIG. 1.

In this embodiment of the present invention, the display device 100 comprises: a first display panel 101, a second display panel 102, a polarizing plate 103 and an optical rotation plate 104, wherein the first display panel 101, the polarizing plate 103, the optical rotation plate 104, and the second display panel 102 are arranged in parallel. The polarizing plate 103 is disposed between the first display panel 101 and the second display panel 102. The optical rotation plate 104 is disposed between the polarizing plate 103 and the second display panel 102. The second display panel 102, the optical rotation plate 104, the polarizing plate 103, and the first display panel 101 are overlaid integrally in sequence along the first direction 201.

The first display panel 101 is configured to emit a first light 1011 along a first direction 201 and also emit a second light 1012 along a second direction 202 opposite to the first direction 201. The first light 1011 is a light beam where a first image displayed on the first display panel 101 corresponds on the first direction 201, and the second light 1012 is a light beam where the first image corresponds on the second direction 202. In this embodiment of the present invention, the first display panel 101 is a transparent organic light emitting diode (OLED) panel configured to display the first image on the first direction 201 and the second direction 202.

The first direction 201 is perpendicular to a plane where the first display panel 101 is located, and the first direction 201 is a direction where a gravity center or a center of the second display panel 102 is directed towards a gravity center or a center of the first display panel 101.

The polarizing plate 103 is provided with converting the second light 1012 into a first linearly polarized light having a first polarization direction 1031.

The second display panel 102 is configured to emit a third light 1021 along the first direction 201 and reflect the second light 1012 along the first direction 201, and the third light 1021 is a light beam where a second image displayed on the second display panel 102 corresponds on the first direction 201. In this embodiment of the present invention, the second display panel 102 is a top-emitting OLED. Namely, a surface of the second display panel 102 that faces the first display panel 101 is a light exiting surface, and a surface of the second display panel 102 that faces away from the first display panel 101 is a light reflecting surface. The light reflecting surface is disposed with a light reflecting material so that the light emitting into the light exiting surface is reflected from the light exiting surface through the light reflecting surface.

The optical rotation plate 104 is provided with converting the second light 1013 (like a circularly polarized light or a third linearly polarized light) reflected by the second display panel 102, into a second linearly polarized light having a second polarization direction perpendicular to the first polarization direction 1031.

The polarizing plate 103 is further configured to block the second linearly polarized light passing therethrough. Therefore, the second light 1013 reflected by the second display panel 102 cannot pass through the first display panel 101.

In this embodiment of the present invention, the optical rotation plate 104 is further provided with the third light 1021 (a fourth linearly polarized light) passing therethrough.

The polarizing plate 103 is further configured to convert the third light 1021 into the fourth linearly polarized light having the first polarization direction 1031.

The first display panel 101 is further provided with the third light 1021 transmitting therethrough.

By the technical solution mentioned above, since the first display panel 101 and the second display panel 102 have a certain distance therebetween, the first image displayed on the first display panel 101 and the second image displayed on the second display panel 102 both are overlaid together to form a stereoscopic image. The stereoscopic image has a view depth of field constructed by the first display panel 101 and the display panel. In addition, since the first image is a full resolution image so that the stereoscopic image overlaid from the first image and the second image has a full resolution, either. In contrast to the feature of displaying only half resolution of a stereoscopic image by a conventional 3D display, the display device 100 of the present invention can provide higher-quality stereoscopic images. Furthermore, the display device 100 of the present invention can display 2D images and 3D images, simultaneously.

In this embodiment of the present invention, the optical rotation plate is a quarter-wave plate. The quarter-wave plate is further configured to convert the first linearly polarized light into a circularly polarized light having a first rotation state. For example, the first rotation state is a right-handed state.

The quarter-wave plate is further provided with converting the circularly polarized light in the second rotation state into the second linearly polarized light.

In the embodiment of the present invention mentioned above, the first rotation state can be a left-handed state. Correspondingly, the second rotation state can be a right-handed state.

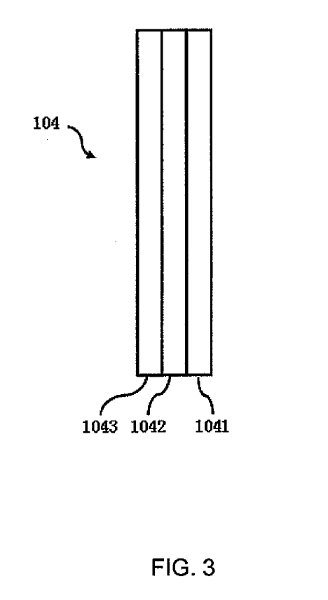

A difference of a display device according to a second embodiment of the present invention from the described-above first embodiment is that the optical rotation plate is a liquid crystal cell. Referring to FIG. 3, the liquid crystal cell comprises: a first substrate 1041, a liquid crystal layer 1042, and a second substrate 1043. The first substrate 1041 and the second substrate 1042 are overlaid integrally. Each of the first substrate 1041 and the second substrate 1042 is disposed with a transparent electrode, such as ITO (Indium Tin Oxide). The liquid crystal layer 1042 has liquid crystal molecules. The liquid crystal layer 1042 is disposed between the first substrate 1041 and the second substrate 1043. The first substrate 1041 and the second substrate 1043 apply an electric field on the liquid crystal molecules to commonly control a deflected state of the liquid crystal molecules so that a deflection direction of the first linearly polarized light is changed.

The liquid crystal cell is configured to convert the first linearly polarized light into the third linearly polarized light having a third polarization direction.

The second display panel 102 is configured to reflect the third linearly polarized light along the first direction 201.

The liquid crystal cell is configured to convert the third linearly polarized light emitted by the second display panel 102, into the second linearly polarized light.

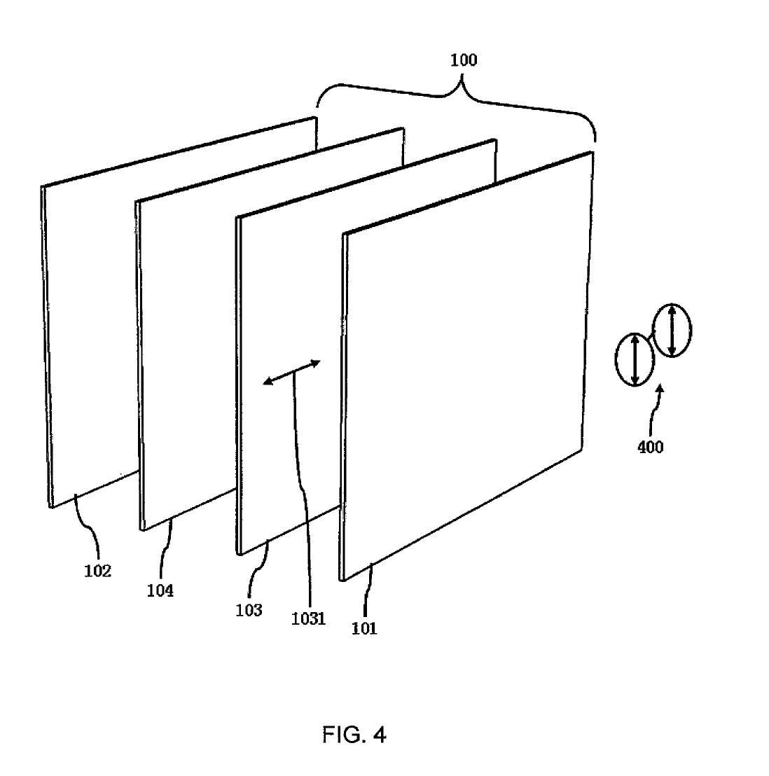

FIG. 4 is a schematic view of the display system according to the first embodiment of the present invention.

In this embodiment of the present invention, the display system comprises the display device 100, as mentioned above and polarized glasses 400. The polarized glasses 400 have a light transmission direction. The light transmission direction is perpendicular to the first polarization direction 1031. The polarized glasses 400 are provided with passing therethrough of a light beam (as the first light 1011) corresponded to by the first image displayed on the first display panel 101, and with blocking passing therethrough of a light beam (as the third light 1021) corresponded to by the second image displayed on the second display panel 102.

By the above technical solution, when wearing the polarized glasses 400, the user's eyes only receive the light beam emitted by the first display panel 101, and the light beam emitted by the second display panel 102 will be absorbed/filtered/blocked by the polarized glasses 400. Thus, the user will see only an image displayed on the first display panel 101. Namely, the image is a 2D image. Accordingly, the display system of the present invention can simultaneously view the 2D image and the 3D image.

As described above, although the present invention has been described with the preferred embodiments thereof, those skilled in the art will appreciate that various modifications, additions, and substitutions are possible, without departing from the scope and the spirit of the invention. Accordingly, the scope of the present invention is intended to be defined only by reference to the claims.

What is claimed is:

1. A display device, comprising:
a first display panel configured to emit a first light along a first direction and emit a second light along a second direction opposite to the first direction, the first light being a light beam where a first image displayed on the first display panel corresponds on the first direction, the second light being a light beam where the first image corresponds on the second direction; and
a second display panel configured to emit a third light along the first direction and reflect the second light along the first direction, the third light being a light beam where a second image displayed on the second display panel corresponds on the first direction;
wherein the first display panel is further provided with the third light transmitting therethrough, the first direction is perpendicular to a plane where the first display panel is located, the first direction is a direction where a gravity center or a center of the second display panel is directed towards a gravity center or a center of the first display panel, the first display panel and the second display panel are overlaid integrally in sequence along the first direction;
the display device further comprising:
a polarizing plate disposed between the first display panel and the second display panel, and provided with converting the second light into a first linearly polarized light having a first polarization direction; and
an optical rotation plate disposed between the polarizing plate and the second display panel, and provided with converting the second light reflected by the second display panel, into a second linearly polarized light having a second polarization direction perpendicular to the first polarization direction;
the polarizing plate further configured to block the second linearly polarized passing therethrough.

2. The display device according to claim 1, wherein the optical rotation plate is a quarter-wave plate;
the quarter-wave plate is configured to convert the first linearly polarized light into a circularly polarized light having a first rotation state;
the second display panel reflects the circularly polarized light in the first rotation state along the first direction to make the circularly polarized light having a second rotation state;
the quarter-wave plate is further configured to convert the circularly polarized light having the second rotation state, into the second linearly polarized light.

3. The display device according to claim 2, wherein the first rotation state is a right-handed state/left-handed state, and the second rotation state is a left-handed state/right-handed state.

4. The display device according to claim 1, wherein the optical rotation plate is a liquid crystal cell;
the liquid crystal cell is configured to convert the first linearly polarized light into a third linearly polarized light having a third polarization direction;
the second display panel is further configured to reflect the third linearly polarized light along the first direction;
the liquid crystal cell is configured to convert the third linearly polarized light emitted by the second display panel, into the second linearly polarized light.

5. The display device according to claim 4, wherein the liquid crystal cell comprises:
a first substrate;
a liquid crystal layer; and
a second substrate;
wherein the first substrate and the second substrate are overlaid integrally, the liquid crystal layer has liquid crystal molecules and disposed between the first substrate and the second substrate, each of which is disposed with a transparent electrode, the first substrate and the second substrate apply an electric field on the liquid crystal molecules to commonly control a deflected state of the liquid crystal molecules so that a deflection direction of the first linearly polarized light is changed.

6. The display device according to claim 1, wherein the optical rotation plate is further provided with the third light passing therethrough;
the polarizing plate is configured to convert the third light passing through the optical rotation plate, into a fourth linearly polarized light having the first polarization direction.

7. A display device, comprising:
a first display panel configured to emit a first light along a first direction and emit a second light along a second direction opposite to the first direction, the first light being a light beam where a first image displayed on the first display panel corresponds on the first direction, the second light being a light beam where the first image corresponds on the second direction; and
a second display panel configured to emit a third light along the first direction and reflect the second light along the first direction, the third light being a light beam where a second image displayed on the second display panel corresponds on the first direction;
wherein the first display panel is further provided with the third light transmitting therethrough, the first direction is perpendicular to a plane where the first display panel is located, the first display panel and the second display panel are overlaid integrally in sequence along the first direction.

8. The display device according to claim 7, wherein the display device further comprises:
a polarizing plate disposed between the first display panel and the second display panel, and provided with converting the second light into a first linearly polarized light having a first polarization direction; and
an optical rotation plate disposed between the polarizing plate and the second display panel, and provided with converting the second light reflected by the second display panel, into a second linearly polarized light having a second polarization direction perpendicular to the first polarization direction;
the polarizing plate further configured to block the second linearly polarized passing therethrough.

9. The display device according to claim 8, wherein the optical rotation plate is a quarter-wave plate;
the quarter-wave plate is configured to convert the first linearly polarized light into a circularly polarized light having a first rotation state;
the second display panel reflects the circularly polarized light in the first rotation state along the first direction to make the circularly polarized light having a second rotation state;
the quarter-wave plate is further configured to convert the circularly polarized light having the second rotation state, into the second linearly polarized light.

10. The display device according to claim 9, wherein the first rotation state is a right-handed state/left-handed state, and the second rotation state is a left-handed state/right-handed state.

11. The display device according to claim 8, wherein the optical rotation plate is a liquid crystal cell;
the liquid crystal cell is configured to convert the first linearly polarized light into a third linearly polarized light having a third polarization direction;
the second display panel is further configured to reflect the third linearly polarized light along the first direction;
the liquid crystal cell is configured to convert the third linearly polarized light emitted by the second display panel, into the second linearly polarized light.

12. The display device according to claim 11, wherein the liquid crystal cell comprises:
a first substrate;
a liquid crystal layer; and
a second substrate;
wherein the first substrate and the second substrate are overlaid integrally, the liquid crystal layer has liquid crystal molecules and disposed between the first substrate and the second substrate, each of which is disposed with a transparent electrode, the first substrate and the second substrate apply an electric field on the liquid crystal molecules to commonly control a deflected state of the liquid crystal molecules so that a deflection direction of the first linearly polarized light is changed.

13. The display device according to claim 8, wherein the optical rotation plate is further provided with the third light passing therethrough;
the polarizing plate is configured to convert the third light passing through the optical rotation plate, into a fourth linearly polarized light having the first polarization direction.

14. A display system, comprising:
polarized glasses; and
a first display panel configured to emit a first light along a first direction and emit a second light along a second direction opposite to the first direction, the first light being a light beam where a first image displayed on the first display panel corresponds on the first direction, the second light being a light beam where the first image corresponds on the second direction; and
a second display panel configured to emit a third light along the first direction and reflect the second light along the first direction, the third light being a light beam where a second image displayed on the second display panel corresponds on the first direction;
wherein the first display panel is further provided with the third light transmitting therethrough, the first display panel and the second display panel are overlaid integrally in sequence along the first direction.

15. The display system according to claim 14, wherein the display device further comprises:
a polarizing plate disposed between the first display panel and the second display panel, and provided with converting the second light into a first linearly polarized light having a first polarization direction; and
an optical rotation plate disposed between the polarizing plate and the second display panel, and provided with converting the second light reflected by the second display panel, into a second linearly polarized light having a second polarization direction perpendicular to the first polarization direction;
the polarizing plate further configured to block the second linearly polarized passing therethrough.

16. The display system according to claim 15, wherein the optical rotation plate is a quarter-wave plate;
the quarter-wave plate is configured to convert the first linearly polarized light into a circularly polarized light having a first rotation state;
the second display panel reflects the circularly polarized light in the first rotation state along the first direction to make the circularly polarized light having a second rotation state;
the quarter-wave plate is further configured to convert the circularly polarized light having the second rotation state, into the second linearly polarized light.

17. The display system according to claim 16, wherein the first rotation state is a right-handed state/left-handed state, and the second rotation state is a left-handed state/right-handed state.

18. The display system according to claim 15, wherein the optical rotation plate is a liquid crystal cell;
the liquid crystal cell is configured to convert the first linearly polarized light into a third linearly polarized light having a third polarization direction;
the second display panel is further configured to reflect the third linearly polarized light along the first direction;
the liquid crystal cell is configured to convert the third linearly polarized light emitted by the second display panel, into the second linearly polarized light.

19. The display system according to claim 18, wherein the liquid crystal cell comprises:
a first substrate;
a liquid crystal layer; and
a second substrate;
wherein the first substrate and the second substrate are overlaid integrally, the liquid crystal layer has liquid crystal molecules and disposed between the first substrate and the second substrate, each of the first substrate and the second substrate is disposed with a transparent electrode, the first substrate and the second substrate apply an electric field on the liquid crystal molecules to commonly control a deflected state of the liquid crystal molecules so that a deflection direction of the first linearly polarized light is changed.

20. The display system according to claim 15, wherein the optical rotation plate is further provided with the third light passing therethrough;
the polarizing plate is configured to convert the third light passing through the optical rotation plate, into a fourth linearly polarized light having the first polarization direction.
